(19) United States
(12) Patent Application Publication
(10) Pub. No.: US 2025/0065529 A1
(43) Pub. Date: Feb. 27, 2025

(54) METHOD AND DEVICES FOR WORKPIECE SEPARATION AND FOR DIVIDING UP A REMAINING GRID OF A WORKPIECE SEPARATION

(71) Applicant: TRUMPF Werkzeugmaschinen SE + Co. KG, Ditzingen (DE)

(72) Inventors: Patrick Wowtscherk, Neschwitz (DE); Andreas Schmidt, Hochkirch (DE); Ralf Mueller, Dohma (DE); Eduard Pfeiffer, Boxdorf (DE)

(21) Appl. No.: 18/944,005

(22) Filed: Nov. 12, 2024

Related U.S. Application Data
(63) Continuation of application No. PCT/EP2023/061628, filed on May 3, 2023.

(30) Foreign Application Priority Data
May 13, 2022 (DE) 10 2022 112 072.4

(51) Int. Cl. B26F 3/00; B23K 26/00

(52) U.S. Cl. CPC B26F 3/002; B23K 26/0093

(57) ABSTRACT

A method for shredding a scrap skeleton produced as a machining product of separating machining of a plate-like workpiece and having a scrap skeleton main plane is provided. The method includes creating an incomplete joint having a course along a separating line running in a longitudinal direction. The scrap skeleton is machined for separation along the separating line. A breakable residual connection arranged along the separating line is established between a first scrap skeleton part and a second scrap skeleton part. The method further includes, after the incomplete joint is created, deflecting the first scrap skeleton part and the second scrap skeleton part relative to one another perpendicularly to the scrap skeleton main plane so that the residual connection between the first scrap skeleton part and the second scrap skeleton part breaks, thereby separating the first scrap skeleton part and the second scrap skeleton part from one another.

### CROSS REFERENCE TO RELATED APPLICATIONS

This application is a continuation of International Application No. PCT/EP2023/061628 (WO 2023/217600 A1), filed on May 3, 2023, and claims benefit to German Patent Application No. DE 10 2022 112 072.4, filed on May 13, 2022. The aforementioned applications are hereby incorporated by reference herein.

### FIELD

Embodiments of the present invention relate to a shredding method for shredding a scrap skeleton which is produced as a machining product of separating machining of a plate-like workpiece, in particular a metal sheet, and has a scrap skeleton main plane, Embodiments of the present invention also relate to a machining method for separating machining of a plate-like workpiece, in particular a metal sheet, wherein a workpiece part and a scrap skeleton, the scrap skeleton at least partially enclosing the workpiece part, are produced by separating machining of the workpiece as machining products, and wherein, after the workpiece part and the scrap skeleton are produced, the scrap skeleton is shredded, Embodiments of the present invention also relate to a shredding device and a machining device for carrying out the abovementioned methods. Embodiments of the present invention further relate to computer programs for carrying out the abovementioned method by means of the abovementioned devices, and also computer program products for producing computer programs of this kind.

### BACKGROUND

In applications for separating machining of workpieces, in particular separating machining of metal sheets, one or more workpiece parts are cut free from a starting workpiece and in the process a scrap skeleton is produced as a waste product, the scrap skeleton being adjacent to the cut-free workpiece part or parts at least over a portion of its circumference. For removal from the vicinity of the machine used for workpiece machining, the scrap skeleton is shredded, in particular when the scrap skeleton would otherwise be impossible or difficult to handle on account of its dimensions. The need to shred the scrap skeleton arises, for example, in cases of separating machining of metal sheets in which a raw metal sheet is unwound from a coil as the starting workpiece and then machined for separation in sections and so as to produce a scrap skeleton extending over several machining sections.

Prior art of this generic type is disclosed in EP 1 402 986 A1. This document relates to a method and a device for cutting metal sheet blanks out of a raw metal sheet which has previously been unwound from a coil. After passing through an alignment device, the raw metal sheet unwound from the coil arrives at a laser cutting machine at which the metal sheet blanks and a scrap skeleton surrounding the metal sheet blanks are produced. The metal sheet blanks are then discharged from the laser cutting machine and the scrap skeleton is broken down at a disposal station arranged downstream of the laser cutting machine.

### SUMMARY

Embodiments of the present invention provide a method for shredding a scrap skeleton produced as a machining product of separating machining of a plate-like workpiece and having a scrap skeleton main plane. The method includes creating an incomplete joint having a course along a separating line running in a longitudinal direction of the incomplete joint on the scrap skeleton. The scrap skeleton is machined for separation along the separating line. A breakable residual connection arranged along the separating line is established between a first scrap skeleton part and a second scrap skeleton part. The first skeleton part is arranged on a first side of the incomplete joint and forming a free end of the scrap skeleton, and the second scrap skeleton part is arranged on a second side of the incomplete joint as a remaining scrap skeleton. The method further includes, after the incomplete joint is created, deflecting the first scrap skeleton part and the second scrap skeleton part relative to one another perpendicularly to the scrap skeleton main plane so that the residual connection between the first scrap skeleton part and the second scrap skeleton part breaks, thereby separating the first scrap skeleton part and the second scrap skeleton part from one another.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a machining device in the form of a coil laser cutting installation for separating machining of a metal sheet according to some embodiments;

FIG. 2 shows the region A of the machining device according to FIG. 1 in a first machining situation in a view in the direction of an arrow P in FIG. 1, according to some embodiments;

FIG. 3 shows the detail B in FIG. 2, according to some embodiments;

FIG. 4 shows the detail C in FIG. 2, according to some embodiments;

FIG. 5 shows the region A of the machining device according to FIG. 1 in a second machining situation in a view in the direction of an arrow P in FIG. 1, according to some embodiments;

FIG. 6 shows the detail D in FIG. 5, according to some embodiments;

FIG. 7 shows the detail E in FIG. 5, according to some embodiments;

FIG. 8 shows the detail F in FIG. 5, according to some embodiments; and

FIG. 9 shows possible ways of guiding cutting on the machining device according to FIG. 1 when creating an incomplete joint on a scrap skeleton in a third machining situation, according to some embodiments.

### DETAILED DESCRIPTION

Embodiments of the present invention can allow a scrap skeleton which is produced as a machining product of separating machining of a workpiece, in particular separating machining of a metal sheet, to be shred using means that are simple.

As part of the shredding method according to embodiments of the invention and on the shredding device according to embodiments of the invention, an incomplete joint is created on a scrap skeleton to be shred by separating machining of the scrap skeleton along a separating line. The joint is incomplete because a breakable residual connection is established between a first scrap skeleton part and a second scrap skeleton part. After the incomplete joint is created, the first scrap skeleton part and the second scrap skeleton part are deflected relative to one another perpendicularly to the scrap skeleton main plane in such a way that the residual connection between the first scrap skeleton part and the second scrap skeleton part breaks and the first scrap skeleton part and the second scrap skeleton part are separated from one another in this way.

Therefore, according to embodiments of the invention, no expensive mechanical devices and no time-consuming separating machining of the scrap skeleton which significantly delays the machining process are needed for finally breaking down a scrap skeleton. Instead, it suffices that the scrap skeleton parts to be separated from one another are deflected relative to one another in a suitable manner, until the residual connection between the scrap skeleton parts breaks.

The residual connection between the scrap skeleton parts can be provided at one or several, preferably at at least two, connecting points. If the residual connection between the scrap skeleton parts is established at several connecting points, the connecting points are arranged along the separating line running in the longitudinal direction of the incomplete joint.

The design of the residual connection, in particular the dimensions of the residual connection, is/are dependent on the respective application and empirically determined. The material of the residual connection determines its breaking strength and is therefore important for the dimensions of the residual connection.

The shredding method according to embodiments of the invention and the shredding device according to embodiments of the invention are integrated into the machining method according to embodiments of the invention and into the machining device according to embodiments of the invention. The workpiece support, on which the workpiece is supported as it is machined for separation, is simultaneously used as a scrap skeleton support here. The incomplete joint between the scrap skeleton parts to be separated from one another can be produced with direct correlation in time with the separating machining of the workpiece for creating the workpiece part or parts.

The workpiece parts can be completely separated from the scrap skeleton during machining of the workpiece. As an alternative, it is also possible to leave a residual connection between the scrap skeleton and the workpiece parts, the residual connection being able to be formed, in particular, by what are known as “microjoints”. Leaving microjoints between the scrap skeleton and the workpiece parts is advisable in cases in which the scrap skeleton and the workpiece parts are still jointly handled after the separating machining of the workpiece, as may be the case when transferring the workpiece parts to an unloading position, for example.

In order to carry out the shredding method according to embodiments of the invention, the shredding device according to embodiments of the invention provided with a numerical controller is controlled by means of the computer program. A method for creating the computer program, and a computer program product for carrying out the method.

The computer program is provided for carrying out the machining method according to embodiments of the invention on the numerically controlled machining device according to embodiments of the invention.

The residual connection between the first scrap skeleton part and the second scrap skeleton part can be produced, for example, in a separate joining process, for example by establishing a welded connection between the scrap skeleton parts.

It is preferred according to embodiments of the invention to establish a breakable residual connection between the first scrap skeleton part and the second scrap skeleton part by way of a connection forming the breakable residual connection being left between the first scrap skeleton part and the second scrap skeleton part during the separating machining of the scrap skeleton along the separating line.

In addition to the breaking strength of the scrap skeleton material, the thickness of the scrap skeleton is important for the breakability of the residual connection and consequently for the dimensions of the residual connection.

When experimentally carrying out the shredding method according to embodiments of the invention, functionally reliable separation of the scrap skeleton parts depending on the scrap skeleton material was ensured with a total extent of the residual connection along the separating line of at least 1 divided by the workpiece thickness (1:d) to 4 divided by the workpiece thickness (4:d).

Different separating methods can be used for separating machining of the scrap skeleton, just like for separating machining of the workpiece for producing the workpiece part or parts and the scrap skeleton. Machining of the scrap skeleton and/or the workpiece by means of a laser separating beam is preferred according to embodiments of the invention. However, in particular, punching machining of the scrap skeleton and/or of the workpiece would also be conceivable.

In a further preferred refinement of the machining method according to embodiments of the invention, one and the same separating tool is used for producing at least one workpiece part and a scrap skeleton from the workpiece to be machined and for creating the incomplete joint on the scrap skeleton.

In a preferred refinement of the shredding method according to embodiments of the invention, the residual connection between the first scrap skeleton part and the second scrap skeleton part remaining at the incomplete joint is destroyed using gravity and therefore automatically. Therefore, mechanical auxiliary means for destroying the residual connection between the first scrap skeleton part and the second scrap skeleton part can be dispensed with.

In a further refinement of the shredding method according to embodiments of the invention, removing the support, which acts in the direction of gravity, for the scrap skeleton part to be deflected in relation to the other scrap skeleton part, the removal being needed for utilizing gravity, is implemented by moving the scrap skeleton in a movement direction, wherein the first scrap skeleton part, which leads in the movement direction of the scrap skeleton, is moved beyond a scrap skeleton support supporting the scrap skeleton into a region in which the scrap skeleton part is released in the direction of gravity for deflection under the action of gravity. The shredding device according to embodiments of the invention is designed for carrying out this variant of the shredding method according to embodiments of the invention.

The shredding method according to embodiments of the invention is implemented as part of the machining method according to embodiments of the invention. In the process, the workpiece to be machined for separation is moved to a machining position by way of a positioning movement, which is executed in a workpiece advancing direction, in which machining position the workpiece is oriented perpendicularly to the direction of gravity and supported in the direction of gravity. A workpiece support, which simultaneously forms the scrap skeleton support, is used to support the workpiece in the direction of gravity. Owing to separating machining of the workpiece arranged in the machining position, at least one workpiece part and the scrap skeleton are produced and the incomplete joint between the scrap skeleton parts to be separated from one another at a later time and having a course in the transverse direction to the workpiece advancing direction is also created on the scrap skeleton. The scrap skeleton is then moved in the workpiece advancing direction now provided as the movement direction of the scrap skeleton, until the scrap skeleton part, which leads in the workpiece advancing direction, arrives at a position on the other side of the workpiece support and is deflected in the direction of gravity in relation to the workpiece part, which remains on the workpiece support, under the action of gravity in this way and on account of the destruction of the residual connection between the scrap skeleton parts, this destruction being associated with the deflection, is separated from the scrap skeleton part remaining on the workpiece support.

Embodiments of the present invention relate to machining methods, in the case of which a workpiece is moved in the workpiece advancing direction in steps into a machining position on the workpiece support and is then machined for separation in sections. With the adjustment of the workpiece to a machining position, according to the invention, a scrap skeleton part produced during previous workpiece machining arrives at a position on the other side of the workpiece support and therefore a position in which it is separated from the trailing scrap skeleton part, to which it was previously connected via the residual connection created on the scrap skeleton, under the action of gravity.

Embodiments of the present invention relate to the case of machining a workpiece unwound from a coil which is relevant in practice.

In a development of the method according to embodiments of the invention, the scrap skeleton part separated from the further scrap skeleton part is supplied to a scrap skeleton part support, in particular a collection container for the scrap skeleton parts, under the action of gravity.

In the interests of creating the incomplete joint in a functionally reliable manner, it is provided that the incomplete joint is created by the scrap skeleton being machined for separation in such a way that the incomplete joint runs on at least one side of the residual connection between the first scrap skeleton part and the second scrap skeleton part and opens into a free edge of the scrap skeleton which is remote from the residual connection along the separating line. In this variant of the shredding method according to embodiments of the invention, only low requirements in respect of accuracy apply for the end position of a separating tool, which is used for creating the incomplete joint, relative to the edge of the scrap skeleton. It is only necessary to ensure that the end position of the separating tool is situated on the other side of the scrap skeleton edge. The exact distance of the end position of the separating tool from the scrap skeleton edge is immaterial here.

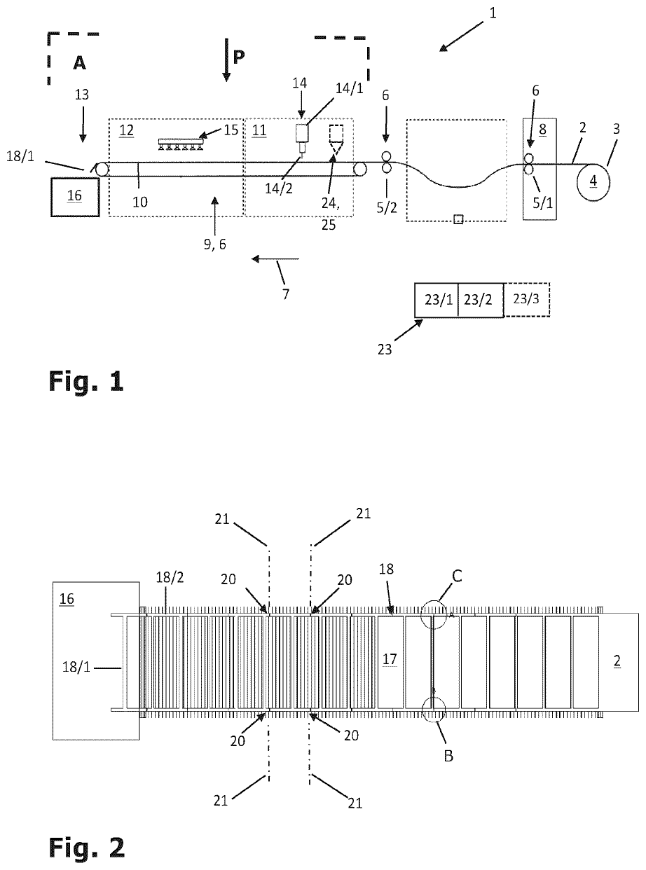

FIG. 1 shows a machining device in the form of an installation 1 for separating machining of a workpiece in the form of a metal sheet 2 which is in the form of a sheet-metal tape and is wound up on a reel 4 as a coil 3. Motor-driven drive roller pairs 5/1, 5/2 are part of a workpiece advancing device or metal sheet advancing device 6, by means of which the metal sheet 2 is unwound from the coil 3 and moved in a workpiece advancing direction or metal sheet advancing direction 7.

As it moves in the metal sheet advancing direction 7, the metal sheet 2, after passing through an alignment device 8, arrives at a machining position on a workpiece support or metal sheet support 9. In the illustrated example, the metal sheet support 9 is continuously circulating and has support strips for the metal sheet 2 which run in the transverse direction to the metal sheet advancing direction 7. The metal sheet support 9 is driven in a manner matched to the drive roller pairs 5/1, 5/2 and moves by way of an upper strand 10 jointly with the metal sheet 2 supported on it in the metal sheet advancing direction 7. The metal sheet support 9 is therefore likewise part of the metal sheet advancing device 6.

The metal sheet support 9 is arranged in a working region A of the installation 1. In the working region A, a cutting region 11 is followed by a sorting region 12, and the sorting region 12 is followed by a disposal region 13, in the metal sheet advancing direction 7.

A laser flat-bed machine 14 of conventional design is arranged in the cutting region 11 of the working region A for separating machining of the metal sheet 2. For reasons of clarity, only one laser cutting head 14/1 of the laser flat-bed machine 14, the laser cutting head emitting a laser separating beam 14/2 as the separating tool, is illustrated in FIG. 1.

The sorting region 12 of the working region A is equipped with a conventional suction frame 15. A collection container 16 is placed beneath a free end of the metal sheet support 9 in the disposal region 13.

For separating machining, the metal sheet 2 is moved in steps by way of a positioning movement in the metal sheet advancing direction 7 by means of the metal sheet advancing device 6 and arranged in the machining position in the cutting region 11 of the working region A in this way. In the machining position, the metal sheet 2 is oriented with its main plane perpendicular to the direction of gravity. The metal sheet 2 situated in the machining position is supported by the metal sheet support 9 in the direction of gravity.

The metal sheet 2 is machined for separation by means of the laser flat-bed machine 14 in the machining position. In the process, the laser cutting head 14/1 is moved in the usual manner with a two-axis movement, executed in a horizontal plane, relative to the metal sheet 2 resting on the metal sheet support 9. The laser separating beam 14/2 is directed onto the metal sheet 2 by the laser cutting head 14/1 during its working movement.

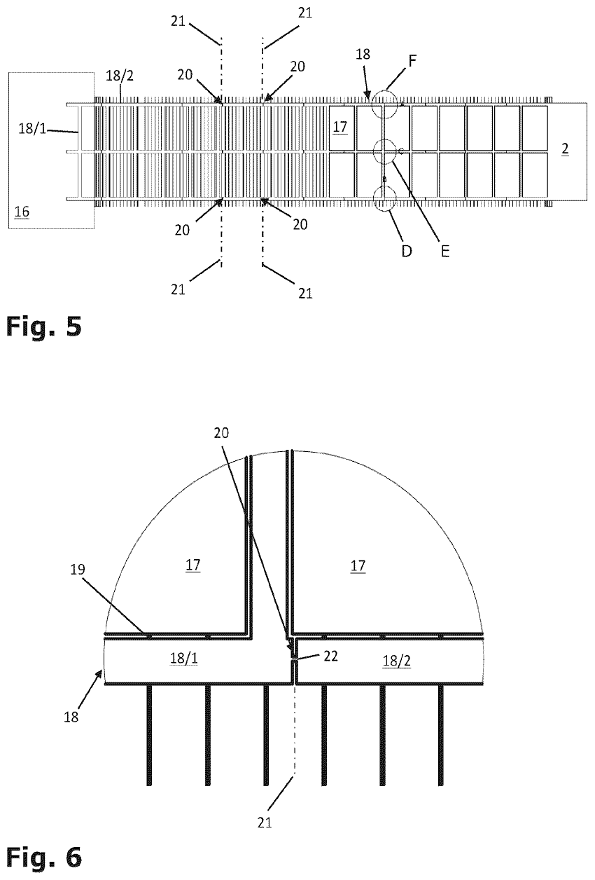

Two possible examples of separating machining of the metal sheet 2 by means of the laser flat-bed machine 14 are shown in FIGS. 2 and 5.

In both cases, workpiece parts and metal sheet parts 17 and a scrap skeleton 18 are produced from the metal sheet 2 as machining products by means of the laser cutting head 14/1. The scrap skeleton 18 is then machined for separation by means of the laser cutting head 14/1. In this respect, the laser cutting head 14/1 acts both as a workpiece separating device and as a scrap skeleton separating device. After the scrap skeleton 18 is produced, the metal sheet support 9 is also used as a scrap skeleton support which supports the scrap skeleton 18 in the direction of gravity, the scrap skeleton having a scrap skeleton main plane oriented perpendicularly to the direction of gravity.

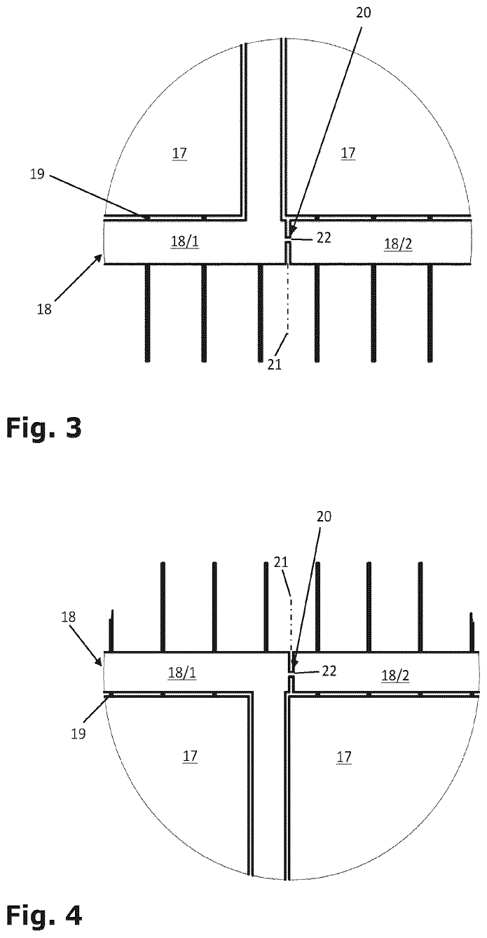

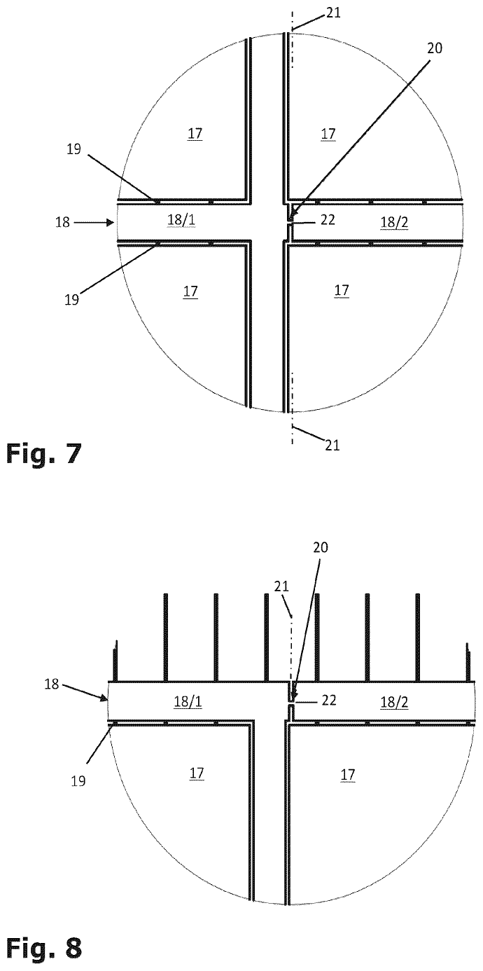

The connection of the metal sheet parts 17 to the scrap skeleton 18 and the condition of the scrap skeleton 18 after it has been machined for separation by means of the laser cutting head 14/1 are shown in detail in FIGS. 3 and 4 for the machining situation according to FIG. 2 and in FIGS. 6 to 8 for the machining situation according to FIG. 5.

Accordingly, the laser cutting head 14/1 has not completely cut free the metal sheet parts 17 during the cutting machining of the metal sheet 2, but rather has left microjoints 19 between the metal sheet parts 17 and the scrap skeleton 18. The microjoints 19 are firstly provided in such a way that they fix the metal sheet parts 17 during movement of the machined metal sheet 2 out of the cutting region 11 to the sorting region 12 of the installation 1 in a defined position in relation to the scrap skeleton 18 and in this way prevent disturbances to the transportation process, for example due to tilting metal sheet parts 17. Secondly, the microjoints 19, on account of their condition in the sorting region 12 of the working region A, also allow functionally reliable unloading of the metal sheet parts 17 from the metal sheet support 9 since they readily break when the metal sheet parts 17 are lifted off from the metal sheet support 9 by means of the suction frame 15 secured to the metal sheet parts 17.

As the scrap skeleton separating device, the laser cutting head 14/1 machines the scrap skeleton 18 in direct correlation in time with the (partial) cutting-free of the workpiece parts 17. In the process, the laser cutting head 14/1 is used as a device for creating incomplete joints 20.

As per FIGS. 3, 4 and 6 to 8, the laser cutting head 14/1 leaves a breakable residual connection 22 between scrap skeleton parts 18/1, 18/2, which are arranged on opposite sides of the incomplete joints 20, during separating machining of the scrap skeleton 18 along a separating line 21 running in the longitudinal direction of the respective incomplete joint 20. The laser cutting head 14/1 accordingly also forms a device for producing the residual connection 22.

The breakable residual connection 22 created on the scrap skeleton 18 by the laser cutting head 14/1 is distributed over several connecting points spaced apart from one another along the separating line 21. In the machining situation according to FIG. 2, the breakable residual connection 22 is formed by two connecting points (details B, C in FIG. 2), and, in the machining situation according to FIG. 5, the residual connection 22 is distributed between three connecting points (details D, E, F in FIG. 5).

After the metal sheet parts 17 are—in the present case partially—separated from the scrap skeleton 18 and after the incomplete joints 20 are created on the scrap skeleton 18, the metal sheet 2 machined for separation in this way is moved out of the cutting region 11 to the sorting region 12 in the metal sheet advancing direction 7. The metal sheet advancing device 6 then also acts as a scrap skeleton advancing device, and the metal sheet advancing direction 7 is now also a movement direction of the scrap skeleton 18. In combination with the transfer of the portion of the metal sheet 2 machined for separation to the sorting region 12, an as yet unmachined portion of the metal sheet 2 is subsequently positioned in the cutting region 11 in the metal sheet advancing direction 7.

In the sorting region 12, the metal sheet parts 17 of the metal sheet portion machined for separation are removed from the metal sheet support 9 in the usual way by means of the suction frame 15 and transported to a metal sheet part store, not shown. At the same time, the subsequently positioned portion of the metal sheet 2 is machined for separation in the cutting region 11 in the manner described above so as to produce further metal sheet parts 17 and so as to extend the scrap skeleton 18.

This is then followed by a further positioning movement of the metal sheet 2, by way of which positioning movement a further portion of the metal sheet 2 arrives at the machining position in the cutting region 11 and the portion of the metal sheet 2 machined for separation immediately beforehand is moved to the sorting region 12. At the same time, that portion of the scrap skeleton 18 from which the metal sheet parts 17 have already been removed arrives at the disposal region 13 of the working region A.

On account of the movement of the scrap skeleton 18 in the metal sheet advancing direction or scrap skeleton advancing direction 7, the scrap skeleton 18 is moved by way of the scrap skeleton part 18/1, which leads in the metal sheet advancing direction or scrap skeleton advancing direction 7, beyond the metal sheet support or scrap skeleton support 9 into a region in which the leading scrap skeleton part 18/1 is released in the direction of gravity for deflection under the action of gravity. Consequently, the leading scrap skeleton part 18/1 is deflected in the direction of gravity in relation to the scrap skeleton part 18/2, which remains on the metal sheet support or scrap skeleton support 9, perpendicularly to the scrap skeleton main plane under the action of gravity in such a way that the residual connection 22 between the scrap skeleton part 18/1 and the scrap skeleton part 18/2 breaks and the scrap skeleton part 18/1 is separated from the scrap skeleton part 18/2 in this way. The metal sheet advancing device or scrap skeleton advancing device 6 therefore forms a deflection device for deflecting the scrap skeleton part 18/1 relative to the scrap skeleton part 18/2 perpendicularly to the scrap skeleton main plane.

After the residual connection 22 is destroyed, the scrap skeleton part 18/1 drops into the collection container 16 of the disposal region 13 under the action of gravity and therefore automatically.

Since the incomplete joints 20 on the scrap skeleton 18 are at a distance from one another in the metal sheet advancing direction or scrap skeleton advancing direction 7 that is smaller than the extent of the interior of the collection container 16 in the same direction, the scrap skeleton part 18/1 is readily deposited in the collection container 16 with a horizontal orientation.

In a corresponding manner, the scrap skeleton parts which follow the scrap skeleton part 18/1 in the metal sheet advancing direction or scrap skeleton advancing direction 7 are separated under the action of gravity and therefore automatically from the combined structure of the scrap skeleton 18 and supplied to the collection container 16.

The described procedures on the installation 1 are numerically controlled. A numerical controller 23 of the installation 1 is shown in a highly schematic manner in FIG. 1. The numerical controller 23 comprises, amongst other things, a control unit 23/1 for the laser cutting head 14/1 and a control unit 23/2 for the metal sheet advancing device or scrap skeleton advancing device 6. The numerical controller 23 is matched to the respective machining situation by means of corresponding computer programs.

In FIG. 1, a laser welding head 24 of a laser welding machine 25, which is provided in addition to the laser flat-bed machine 14 in the case of a further design of the installation 1, is indicated using dashed lines. The numerical controller 23 is supplemented with a control unit 23/3 for the laser welding head 24.

Workpiece parts 17 and a scrap skeleton 18 are produced on the installation 1 modified in the above manner by means of the laser cutting head 14/1 from the metal sheet 2 and then initially continuous joints are created on the scrap skeleton 18. The continuous joints are then closed at points by means of the laser welding head 24 so as to produce incomplete joints 20. The point-type connections produced in this way between scrap skeleton parts 18/1, 18/2 arranged on either side of the incomplete joints 20 form the breakable residual connection 22 between the scrap skeleton parts 18/1, 18/2. Accordingly, in this case, the laser cutting head 14/1 acts on its own as a workpiece separating device and as a scrap skeleton separating device and jointly with the laser welding head 24 as a device for creating incomplete joints 20 on the scrap skeleton 18. The laser welding head 24 is provided as a device for producing the residual connection 22. As an alternative, the welding points can also be created using the laser cutting head 14/1.

The procedures for separating the scrap skeleton parts 18/1, 18/2 from each other under the action of gravity correspond to the procedures described in detail above relating to FIGS. 1 to 8.

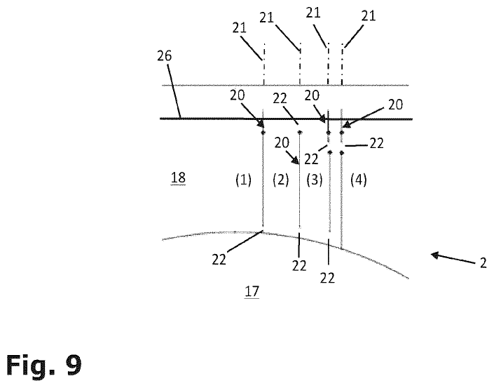

FIG. 9 shows possible ways of guiding cuts when producing an incomplete joint 20 for a further application of separating machining of the metal sheet 2.

The cutting guides (1), (3) and (4) correspond to one another in as much as the incomplete joint 20 is created in all three cases by way of the scrap skeleton 18 being machined for separation along the separating line 21 in such a way that the incomplete joint 20, on at least one side of the residual connection 22, opens into a free edge 26 of the scrap skeleton 18. This cutting guide has the advantage that the end position of the laser separating beam 14/2 directed onto the scrap skeleton 18 by the laser cutting head 14/1 when the incomplete joint 20 is created is subject to only low requirements in respect of accuracy. It is only necessary to ensure that the laser separating beam 14/2, in its end position, is arranged on the other side of the free edge 26 of the scrap skeleton 18. This situation is advantageous in as much as the metal sheet 2, during separating machining, can assume a machining position which does not exactly correspond to the desired position stored in the numerical controller 23 of the installation 1 and forming the basis for the control of the working movement of the laser cutting head 14/1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for shredding a scrap skeleton produced as a machining product of separating machining of a plate-like workpiece and having a scrap skeleton main plane, the method comprising
creating an incomplete joint having a course along a separating line running in a longitudinal direction of the incomplete joint on the scrap skeleton, wherein the scrap skeleton is machined for separation along the separating line, and wherein a breakable residual connection arranged along the separating line is established between a first scrap skeleton part and a second scrap skeleton part, the first skeleton part being arranged on a first side of the incomplete joint and forming a free end of the scrap skeleton and the second scrap skeleton part being arranged on a second side of the incomplete joint as a remaining scrap skeleton, and
after the incomplete joint is created, deflecting the first scrap skeleton part and the second scrap skeleton part relative to one another perpendicularly to the scrap skeleton main plane so that the residual connection between the first scrap skeleton part and the second scrap skeleton part breaks, thereby separating the first scrap skeleton part and the second scrap skeleton part from one another.

2. The method as claimed in claim 1, wherein the breakable residual connection between the first scrap skeleton part and the second scrap skeleton part is established by a connection, wherein the connection forms the breakable residual connection between the first scrap skeleton part and the second scrap skeleton part, the connection being left during the separating machining of the scrap skeleton along the separating line.

3. The method as claimed in claim 1, wherein
the scrap skeleton with the scrap skeleton main plane oriented perpendicularly to a direction of gravity is supported in the direction of gravity by a scrap skeleton support,
the incomplete joint is created on the scrap skeleton that is supported in the direction of gravity by the scrap skeleton support,
after the incomplete joint is created, the scrap skeleton support, which acts in the direction of gravity for the first scrap skeleton part is removed, thereby releasing the first scrap skeleton part for the deflection in the direction of gravity, and
the released first scrap skeleton part is deflected in the direction of gravity in relation to the second scrap skeleton part under an action of gravity so that the residual connection between the first scrap skeleton part and the second scrap skeleton part breaks, thereby the released first scrap skeleton part is separated from the second scrap skeleton part.

4. The method as claimed in claim 3, wherein
the separating line runs in a transverse direction to a movement direction of the scrap skeleton, wherein the scrap skeleton is moved in the transverse direction parallel to the scrap skeleton main plane, after the incomplete joint is created, so that the first scrap skeleton part leads in the movement direction of the scrap skeleton,
after the incomplete joint is created, the support, which acts in the direction of gravity for the first scrap skeleton part, is removed by the first scrap skeleton part being moved beyond the scrap skeleton support in the movement direction into a region in which the first scrap skeleton part is released in the direction of gravity for the deflection under the action of gravity, and
the released first scrap skeleton part is deflected in the direction of gravity in relation to the second scrap skeleton part, which remains on the scrap skeleton support under the action of gravity, so that the residual connection between the first scrap skeleton part and the second scrap skeleton part breaks, thereby the first scrap skeleton part is separated from the second scrap skeleton part.

5. The method as claimed in claim 3, wherein the first scrap skeleton part, after the separation from the second scrap skeleton part, is supplied to a collection container under the action of gravity.

6. The method as claimed in claim 1, wherein the incomplete joint is created by the scrap skeleton being machined for separation along the separating line in such a way that the incomplete joint, on at least one side of the residual connection, opens into a free edge of the scrap skeleton that is remote from the residual connection along the separating line.

7. A method for separating machining of a plate-like workpiece, the method comprising:
producing a workpiece part and a scrap skeleton by the separating machining as machining products, the scrap skeleton at least partially enclosing the workpiece part, and
after the workpiece part and the scrap skeleton are produced, shredding the scrap skeleton in accordance with the method as claimed in claim 1.

8. The method as claimed in claim 7, wherein the separating machining of the workpiece for producing the workpiece part and the scrap skeleton and the creating the incomplete joint are carried out using a same separating tool.

9. The method as claimed in claim 7,
wherein
the workpiece to be machined for separation is arranged in a machining position by a positioning movement in a workpiece advancing direction provided as a movement direction of the scrap skeleton, wherein in the machining position, the workpiece is oriented with a workpiece main plane perpendicular to a direction of gravity and is supported in the direction of gravity by a workpiece support provided as a scrap skeleton support,
as the workpiece is arranged in the machining position, the incomplete joint is created on the scrap skeleton, wherein the incomplete joint is supported in the direction of gravity by the workpiece support and has a course along the separating line which runs in a transverse direction to the workpiece advancing direction,
after the workpiece part is at least partially separated from the scrap skeleton and after the incomplete joint is created on the scrap skeleton, the scrap skeleton is moved in the workpiece advancing direction in such a way that the first scrap skeleton part leads in the workpiece advancing direction,
as the first scrap skeleton part is moved beyond the workpiece support in the workpiece advancing direction into a region in which the first scrap skeleton part is released in the direction of gravity, for the deflection under an action of gravity, and
the released first scrap skeleton part is deflected in the direction of gravity in relation to the second scrap skeleton part, which remains on the workpiece support, under the action of gravity in such a way that the residual connection between the first scrap skeleton part and the second scrap skeleton part breaks, thereby the first scrap skeleton part is separated from the second scrap skeleton part.

10. The method as claimed in claim 9, wherein
the workpiece, on account of the movement of the scrap skeleton in the workpiece advancing direction, is arranged in a further machining position, in which the workpiece is oriented with the workpiece main plane perpendicular to the direction of gravity and is supported in the direction of gravity by the workpiece support,
as the workpiece is arranged in the further machining position, a further workpiece part is at least partially separated from the scrap skeleton by the separating machining of the workpiece, and a further incomplete joint with a further course along a further separating line is created on the scrap skeleton which is supported in the direction of gravity by the workpiece support, the further separating line running in the transverse direction to the workpiece advancing direction, wherein a further breakable residual connection is established between a further first scrap skeleton part arranged on a first side of the further incomplete joint and a further second scrap skeleton part arranged on a second side of the further incomplete joint,
after the further workpiece part is at least partially separated from the scrap skeleton and after the further incomplete joint is created on the scrap skeleton, the scrap skeleton is moved in the workpiece advancing direction in such a way that the further first scrap skeleton part leads in the workpiece advancing direction,
as the further first scrap skeleton part, is moved beyond the workpiece support in the workpiece advancing direction into a region in which the further first scrap skeleton part is released in the direction of gravity for deflection under the action of gravity, and
the released further first scrap skeleton part is deflected in the direction of gravity in relation to the further second scrap skeleton part, which remains on the workpiece support, under the action of gravity in such a way that the further residual connection between the further first scrap skeleton part and the further second scrap skeleton part breaks, thereby separating the further first scrap skeleton part from the further second scrap skeleton part.

11. The method as claimed in claim 9, wherein the workpiece to be machined for separation is unwound from a coil in order to be arranged in the machining position.

12. A shredding device for shredding a scrap skeleton produced as a machining product of separating machining of a plate-like workpiece and having a scrap skeleton main plane,
wherein
the shredding device is configured to create an incomplete joint having a course along a separating line running in a longitudinal direction of the incomplete joint on the scrap skeleton, wherein the shredding device comprises a scrap skeleton separating device and a device for producing a residual connection, wherein the scrap skeleton is machined for separation along the separating line by the scrap skeleton separating device, and wherein the residual connection, which is arranged along the separating line. is established between a first scrap skeleton part, arranged on a first side of the incomplete joint and forming a free end of the scrap skeleton, and a second scrap skeleton part, arranged on the second side of the incomplete joint as a remaining scrap skeleton, and
the shredding device further comprises a deflection device, the deflection device is configured to, after the incomplete joint is created, deflect the first scrap skeleton part and the second scrap skeleton part relative to one another perpendicularly to the scrap skeleton main plane in such a way that the residual connection between the first scrap skeleton part and the second scrap skeleton part breaks, thereby separating the first scrap skeleton part and the second scrap skeleton part from one another.

13. The shredding device as claimed in claim 12, further comprising:
a scrap skeleton support configured to support the scrap skeleton in a direction of gravity, wherein the scrap skeleton main plane is oriented perpendicularly to the direction of gravity,
a scrap skeleton advancing device configured to move the scrap skeleton over the scrap skeleton support in a movement direction of the scrap skeleton,
wherein the incomplete joint is supported in the direction of gravity by the scrap skeleton support, and
wherein the deflection device comprises the scrap skeleton advancing device, wherein the scrap skeleton, after the incomplete joint is created, is moved beyond the scrap skeleton support in the movement direction of the scrap skeleton with the first scrap skeleton part leading in the movement direction of the scrap skeleton into a region in which the first scrap skeleton part is released in the direction of gravity for the deflection under the action of gravity, and wherein the released first scrap skeleton part is deflected in the direction of gravity in relation to the second scrap skeleton part, which remains on the scrap skeleton support, under the action of gravity in such a way that the residual connection between the first scrap skeleton part and the second scrap skeleton part breaks, thereby the first scrap skeleton part is separated from the second scrap skeleton part.

14. A non-transitory computer-readable medium storing a computer program for operating the shredding device as claimed in claim 12, wherein the shredding device comprises a numerical controller, the numerical controller having a first numerical control unit for the scrap skeleton separating device, a second numerical control unit for the device for producing the residual connection, and a third numerical control unit for the deflection device.

15. A machining device for separating machining of a plate-like workpiece, the machining device comprising:
a workpiece separating device configured to produce a workpiece part and a scrap skeleton, the scrap skeleton at least partially enclosing the workpiece part, and
the shredding device as claimed in claim 12 for shredding the scrap skeleton.

18. The machining device as claimed in claim 17, further comprising:
a workpiece advancing device, wherein the workpiece to be machined for separation is capable of being arranged in a machining position by the workpiece advancing device by a positioning movement in a workpiece advancing direction, and
a workpiece support configured to support the workpiece, which is arranged in the machining position and has a workpiece main plane oriented perpendicularly to a direction of gravity,
wherein as the workpiece is arranged in the machining position, the incomplete joint having the course along the separating line which runs in a transverse direction to the workpiece advancing direction is created on the scrap skeleton, which is supported in the direction of gravity by the workpiece support provided as a scrap skeleton support, by separating machining of the scrap skeleton by the scrap skeleton separating device of the shredding device, and
wherein the deflection device of the shredding device comprises the workpiece advancing device provided as a scrap skeleton advancing device, wherein the scrap skeleton, after the incomplete joint is created, is capable of being moved in the workpiece advancing direction provided as a movement direction of the scrap skeleton with the first scrap skeleton part, which leads in the workpiece advancing direction, beyond the workpiece support into a region in which the first scrap skeleton part is released in the direction of gravity for deflection under the action of gravity, and wherein the released first scrap skeleton part is deflected in the direction of gravity in relation to the second scrap skeleton part, which remains on the workpiece support, under the action of gravity in such a way that the residual connection between the first scrap skeleton part and the second scrap skeleton part breaks, thereby the first scrap skeleton part is separated from the second scrap skeleton part.

19. A non-transitory computer-readable medium storing a computer program for operating the machining device as claimed in claim 17.
